(19) United States
(12) Patent Application Publication
(10) Pub. No.: US 2012/0229723 A1
(43) Pub. Date: Sep. 13, 2012

(54) SUBSTRATE FOR LIQUID CRYSTAL DISPLAY DEVICE, LIQUID CRYSTAL DISPLAY DEVICE, AND METHOD FOR DRIVING LIQUID CRYSTAL DISPLAY DEVICE

(76) Inventors: Shohei Katsuta, Osaka-shi (JP); Tetsuya Ide, Osaka-shi (JP); Seiji Ohhashi, Osaka-shi (JP)

(21) Appl. No.: 13/395,951

(22) PCT Filed: Jul. 20, 2010
(86) PCT No.: PCT/JP2010/062194

§ 371 Date: Mar. 14, 2012

(30) Foreign Application Priority Data
Nov. 30, 2009 (JP) 2009-272742

(51) Int. Cl. G02F 1/1343

(52) U.S. Cl. 349/42

(57) ABSTRACT

The present invention provides a liquid crystal display apparatus which allows high-speed driving with maintenance of a high viewing angle characteristic. The liquid crystal display apparatus includes, in one of pixels of a display driving circuit, a gate bus line; a data bus line; a storage capacitor bus line; a first transistor and a second transistor which are connected with the gate bus line and with the data bus line; a liquid crystal capacitor in a first subpixel; a liquid crystal capacitor in a second subpixel; and a third transistor connected with the liquid crystal capacitor in the second subpixel. The gate electrode of the third transistor is connected with a gate bus line (n+2) corresponding to pixels on a second or latter scanning line forward from a scanning signal line corresponding to the third transistors.

### TECHNICAL FIELD

The present invention relates (i) to a substrate for a liquid crystal display apparatus utilized in a display section etc. of an electronic device, (ii) to a liquid crystal display apparatus having the substrate, and (iii) to a method for driving the liquid crystal display apparatus.

### BACKGROUND ART

Recently, liquid crystal display apparatuses are often employed as display apparatuses of televisions, personal computers, portable phones, etc. The liquid crystal display apparatuses have thinner display sections, and have lighter weights, as compared to conventional display apparatuses such as those utilizing cathode-ray tubes. Accordingly, the liquid crystal display apparatus are becoming widespread as thin and lightweight display apparatuses.

The liquid crystal display apparatuses have such a problem that a screen looks whitish when a display section is viewed obliquely. Such a problem is solved by a technique called HGM (Halftone Grayscale Method). HGM is such a technique that two subpixels are provided within one pixel, and different voltages are applied respectively to the subpixels so that such a problem is prevented even when a display section is viewed obliquely.

However, the technique has a problem in that image sticking is caused on a screen. Examples of methods for solving such a problem encompass a technique disclosed in Patent Literature 1. According to Patent Literature 1, a first TFT and a second TFT are connected with an n-th gate bus line; one of two subpixels is connected with a source bus line via the first TFT and the other one is connected with the source bus line via the second TFT; a third TFT connected with an (n+1)th gate bus line is connected with a source electrode of the second TFT; and different voltages are applied respectively to the two subpixels so that image sticking is alleviated, with maintenance of a high viewing angle characteristic.

### CITATION LIST

### Patent Literature

### Patent Literature 1

Japanese Patent Application Publication, Tokukai, No. 2006-133577 A (Publication Date: May 25, 2006)

### SUMMARY OF INVENTION

### Technical Problem

Recently, there is an increasing demand for liquid crystal display apparatuses capable of 3D display. In a case where such a liquid crystal display apparatus capable of 3D display performs 3D display in a time-division manner, it is required to drive the liquid crystal display apparatus at a frequency of at least 120 Hz which is twice as high as normal driving speed. However, the 120-Hz driving is not sufficient in terms of display quality. Therefore, high-speed driving at 240 Hz is required for display to be performed in the time-division manner.

It is conceivable to simultaneously supply scanning signals to every group of two gate bus lines, as a technique for realizing the 240-Hz driving by use of a substrate for a liquid crystal display apparatus of a liquid crystal panel which is driven at 120 Hz. In a case where, e.g., a liquid crystal display panel having 1080 gate bus lines is driven, this technique makes it possible to supply scanning signals to all the 1080 gate bus lines, in time equal to time which is conventionally required for supplying scanning signals to 540 gate bus lines. That is, driving speed is doubled so that the 240-Hz driving is realized. The technique does not require to interchange liquid crystal panels in accordance with a driving method. This makes it possible to avoid needless cost increase.

However, the following problem arises in a case where scanning signals are simultaneously supplied to every group of two gate bus lines by the technique of Patent Literature 1.

Patent Literature 1 discloses such a technique that after a gate bus line is selected so that each of two subpixels is given an electric charge, a next gate bus line is selected with a time lag so that a third transistor is turned on, and this causes redistribution of the electric charge so that a voltage difference is caused between two subpixels. However, in a case where high-speed driving is required as described above, and a plurality of gate bus lines are simultaneously selected, e.g., an n-th and an (n+1)th gate bus lines are simultaneously selected, the (n+1)th gate bus line which follows the n-th gate bus line is selected simultaneously with the n-th gate bus line, without any time lag. Accordingly, a capacitor for redistributing the electric charge is also electrically charged simultaneously with the two subpixels. This causes no redistribution of the electric charge so that no voltage difference is caused between the two subpixels. As a result, a high viewing angle characteristic cannot be maintained.

The present invention was made to solve the problem. A main object of the present invention is to provide (i) that substrate for a liquid crystal display apparatus which allows high-speed driving without cost increase, (ii) a liquid crystal display apparatus, and (iii) a method for driving the liquid crystal display apparatus.

### Solution to Problem

A substrate of the present invention for a liquid crystal display apparatus includes: a plurality of gate bus lines being provided in parallel with each other on a substrate; a plurality of source bus lines being formed so as to intersect with the plurality of gate bus lines with an insulating film interposed between the plurality of source bus lines and the plurality of gate bus lines; a plurality of storage capacitor bus lines being formed in parallel with the plurality of gate bus lines; first transistors; second transistors; each of said first transistors and said second transistors including (i) a gate electrode which is electrically connected with an n-th one of the plurality of gate bus lines and (ii) a source electrode which is electrically connected with one of the plurality of source bus lines, first pixel electrodes each being electrically connected with the drain electrode of a corresponding one of said first transistors; second pixel electrodes each being electrically connected with the drain electrode of a corresponding one of said second transistors, said second pixel electrodes each being separated from said first pixel electrodes; pixel regions each including (I) a first subpixel in which a corresponding one of said first pixel electrodes is provided, and (II) a second subpixel in which a corresponding one of said second pixel electrodes is provided; third transistors each including (a) a gate electrode which is electrically connected with an (n+m)th one of the plurality of gate bus lines, where ‘m’ is an integer of not less than 2, and (b) a drain electrode which is electrically connected with a corresponding one of said second pixel electrodes; and buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film.

According to the arrangement, in a case where e.g., the number of the gate bus lines to be selected simultaneously is two (m=2) in high-speed driving of the liquid crystal display apparatus, selected are the n-th and (n+1)th gate bus lines so that electrically charged is each of two subpixels which are connected respectively with the n-th and (n+1)th gate bus lines. With a time lag, the (n+2)th and (n+3)th gate bus lines are selected. Respective gate electrodes of third transistors provided in pixels corresponding to the n-th gate bus line are connected with the (n+2)th gate bus line. Accordingly, third transistors provided in pixels corresponding to the n-th gate bus line are turned on. Similarly, respective gate electrodes of third transistors provided in pixels corresponding to the (n+1)th gate bus line are connected with the (n+2)th gate bus line.

Accordingly, the third transistors provided in the pixels corresponding to the (n+1)th gate bus line are turned on.

Accordingly, the electric charge retained by a second subpixel out of two subpixels in each of the pixels is given to the buffer capacitor section. The redistribution of the electric charge is thus caused. As a result, a voltage difference is caused between the two subpixels of each of the pixels. Thus, the redistribution of an electric charge is caused not only in a case where the gate bus lines are scanned one by one but also in a case where the ‘m’ number of adjacent gate bus lines are simultaneously scanned.

Thus, the substrate of the present invention for a liquid crystal display apparatus makes it possible to maintain a high viewing angle characteristic even in high-speed driving in which every group of ‘m’ number of gate bus line are selected.

A substrate of the present invention for a liquid crystal display apparatus includes: a plurality of gate bus lines being provided in parallel with each other on a substrate; a plurality of source bus lines being formed so as to intersect with the plurality of gate bus lines via an insulating film; a plurality of storage capacitor bus lines being formed in parallel with the plurality of gate bus lines; first transistors; second transistors; each of said first transistors and said second transistors including (i) a gate electrode which is electrically connected with an n-th one of the plurality of gate bus lines and (ii) a source electrode which is electrically connected with one of the plurality of source bus lines, first pixel electrodes each being electrically connected with the drain electrode of a corresponding one of said first transistors; second pixel electrodes each being electrically connected with the drain electrode of a corresponding one of said second transistors, said second pixel electrodes each being separated from a corresponding one of said first pixel electrodes; pixel regions each including (I) a first subpixel in which a corresponding one of said first pixel electrodes is provided, and (II) a second subpixel in which a corresponding one of said second pixel electrodes is provided; third transistors each including (a) a gate electrode which is electrically connected with a (y×m+1)th one of the plurality of gate bus lines, where ‘m’ is an integer of not less than 2, and ‘y’ is found in such a manner that a quotient is found by dividing ‘n’ by ‘m’ and decimals of the quotient are rounded up to unit, and (b) a drain electrode which is electrically connected with a corresponding one of said second pixel electrodes; and buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film.

According to the arrangement, in a case where high-speed driving of the liquid crystal display apparatus is required, and the number of gate bus lines to be simultaneously selected is, e.g., 2 (m=2), selected are the n-th and (n+1)th gate bus lines so that electrically charged is each of two subpixels which are connected respectively with the n-th and (n+1)th gate bus lines. With a time lag, the (n+2)th and (n+3)th gate bus lines are selected. Respective gate electrodes of third transistors provided in pixels corresponding to the n-th and (n+1)th gate bus lines are connected with the (n+2)th gate bus line. Accordingly, the third transistors are turned on.

Accordingly, the electric charge retained by a second subpixel out of two subpixels in each of the pixels is given to the buffer capacitor section. The redistribution of the electric charge is thus caused. As a result, a voltage difference is caused between the two subpixels of each of the pixels. Thus, the redistribution of an electric charge is caused not only in a case where the gate bus lines are scanned one by one but also in a case where the ‘m’ number of adjacent gate bus lines are simultaneously scanned.

Thus, the substrate of the present invention for a liquid crystal display apparatus makes it possible to maintain a high viewing angle characteristic even in high-speed driving in which every group of ‘m’ number of gate bus line are selected.

A method of the present invention for driving a liquid crystal display apparatus which includes a substrate for the liquid crystal display apparatus, the substrate including: a plurality of gate bus lines being provided in parallel with each other on a substrate; a plurality of source bus lines being formed so as to intersect with the plurality of gate bus lines with an insulating film interposed between the plurality of source bus lines and the plurality of gate bus lines; a plurality of storage capacitor bus lines being formed in parallel with the plurality of gate bus lines; first transistors; second transistors; each of said first transistors and said second transistors including (i) a gate electrode which is electrically connected with an n-th one of the plurality of gate bus lines and (ii) a source electrode which is electrically connected with one of the plurality of source bus lines, first pixel electrodes each being electrically connected with the drain electrode of a corresponding one of said first transistors; second pixel electrodes each being electrically connected with the drain electrode of a corresponding one of said second transistors, said second pixel electrodes each being separated from said first pixel electrodes; pixel regions each including (I) a first subpixel in which a corresponding one of said first pixel electrodes is provided, and (II) a second subpixel in which a corresponding one of said second pixel electrodes is provided; third transistors each including (a) a gate electrode which is electrically connected with an (n+m)th one of the plurality of gate bus lines, where ‘m’ is an integer of not less than 2, and (b) a drain electrode which is electrically connected with a corresponding one of said second pixel electrodes; and buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film, the method includes a step of supplying scanning signals to every group of ‘m’ number of adjacent ones of the plurality of gate bus lines.

The arrangement makes it possible to maintain a high viewing angle characteristic even in high-speed driving in which every group of ‘m’ number of gate bus line are selected.

A method of the present invention for driving a liquid crystal display apparatus which includes a substrate for a liquid crystal display apparatus, the substrate including: a plurality of gate bus lines being provided in parallel with each other on a substrate; a plurality of source bus lines being formed so as to intersect with the plurality of gate bus lines with an insulating film interposed between the plurality of source bus lines and the plurality of gate bus lines; a plurality of storage capacitor bus lines being formed in parallel with the plurality of gate bus lines; first transistors; second transistors; each of said first transistors and said second transistors including (i) a gate electrode which is electrically connected with an n-th one of the plurality of gate bus lines and (ii) a source electrode which is electrically connected with one of the plurality of source bus lines, first pixel electrodes each being electrically connected with the drain electrode of a corresponding one of said first transistors; second pixel electrodes each being electrically connected with the drain electrode of a corresponding one of said second transistors, said second pixel electrodes each being separated from said first pixel electrodes; pixel regions each including (I) a first subpixel in which a corresponding one of said first pixel electrodes is provided, and (II) a second subpixel in which a corresponding one of said second pixel electrodes is provided; third transistors each including (a) a gate electrode which is electrically connected with a (y×m+1)th one of the plurality of gate bus lines, where ‘m’ is an integer of not less than 2, and ‘y’ is found in such a manner that a quotient is found by dividing ‘n’ by ‘m’ and decimals of the quotient are rounded up to unit, and (b) a drain electrode which is electrically connected with a corresponding one of said second pixel electrodes; and buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film, the method includes a step of supplying scanning signals to every group of ‘m’ number of adjacent ones of the plurality of gate bus lines.

The arrangement makes it possible to maintain a high viewing angle characteristic even in high-speed driving in which every group of ‘m’ number of gate bus line are selected.

### Advantageous Effects of Invention

A liquid crystal display apparatus of the present invention is a liquid crystal display apparatus including in one of pixels of a display driving circuit: a gate bus line; a source bus line; a storage capacitor bus line; first and second transistors connected with the gate bus line and with the source bus line; a liquid crystal capacitor in a first subpixel; a liquid crystal capacitor in a second subpixel; and a third transistor connected with the liquid crystal capacitor in the second subpixel. The gate electrode of the third transistor is connected with a gate bus line corresponding to that line of pixels which is a second or latter one forward from that line of pixels which corresponds to the third transistors.

According to the arrangement, as is the case with the scanning in which the gate bus lines are scanned one by one, the redistribution of an electric charge occurs even in a case where high-speed driving of the liquid crystal display apparatus is required and an ‘m’ number of adjacent gate bus lines are simultaneously scanned. That is, a voltage difference is caused between the two subpixels of each of the pixels. Thus, it is possible to maintain a high viewing angle characteristic even in high-speed driving in which every group of plurality of gate bus lines are selected.

### BRIEF DESCRIPTION OF DRAWINGS

FIG. 1 is a view illustrating a part of equivalent circuits which are provided in a display driving circuit of a liquid crystal display apparatus of Embodiment 1.

FIG. 2 is a view illustrating that equivalent circuit of one of pixels which is provided in the display driving circuit of the liquid crystal display apparatus of Embodiment 1.

FIG. 3 is a view illustrating how an electric charge moves in driving within a pixel defined by an n-th gate bus line and a source bus line in Embodiment 1. (a) of FIG. 3 is a view illustrating a state where the n-th gate bus line is not selected. (b) of FIG. 3 is a view illustrating how the electric charge flows in a case where the n-th gate bus line is selected. (c) of FIG. 3 is a view illustrating a state where the n-th gate bus line is deselected. (d) of FIG. 3 is a view illustrating how the electric charge flows in a case where the n-th bus line is selected.

FIG. 4 is a view illustrating a part of equivalent circuits which are provided in a display driving circuit of a liquid crystal display apparatus of Embodiment 2.

### DESCRIPTION OF EMBODIMENTS

### Embodiment 1

The following describes: a substrate of the present invention for a liquid crystal display apparatus; a liquid crystal display apparatus having the substrate; and a method for driving the liquid crystal display apparatus.

(Arrangement of Liquid Crystal Panel)

First, the following describes an arrangement of a liquid crystal panel that includes a TFT substrate which is a substrate of the present embodiment for a liquid crystal display apparatus. The TFT substrate is connected with: a gate bus line driving circuit having a driver IC for driving a plurality of gate bus lines; and a source bus line driving circuit having a driver IC for driving a plurality of source bus lines. The gate bus line driving circuit supplies a scanning signal to a predetermined gate bus line, in accordance with a predetermined signal supplied from a control circuit. Similarly, the source bus line driving circuit supplies a data signal to a predetermined source bus line, in accordance with a predetermined signal supplied from a control circuit. A first polarization plate is provided on that surface of the TFT substrate which is opposite to its another surface on which TFT elements are provided. A second polarization plate is provided, on that surface of a counter substrate which is opposite to its another surface on which common electrodes are provided, so as to form crossed Nicols with respect to the first polarization plate. A backlight unit is provided on that surface of the first polarization plate which is opposite to its another surface facing the TFT substrate. Further, a liquid crystal layer having a negative dielectric anisotropy is provided between the TFT substrate and the counter substrate on which the common electrodes are provided.

(Arrangement of Substrate)

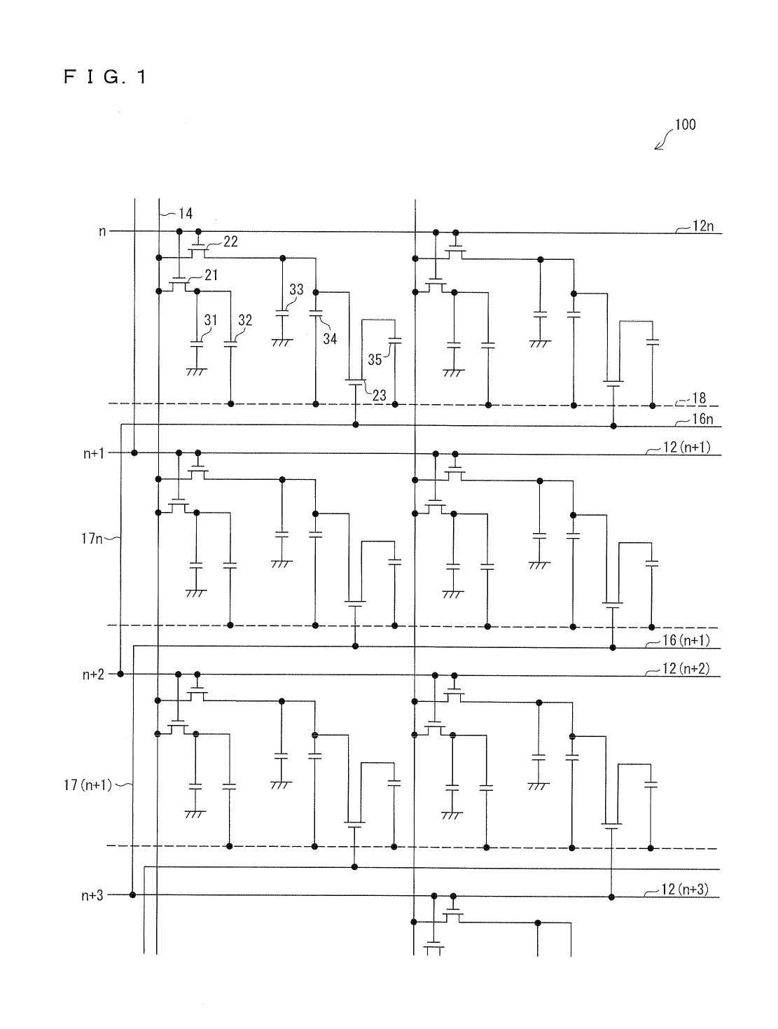

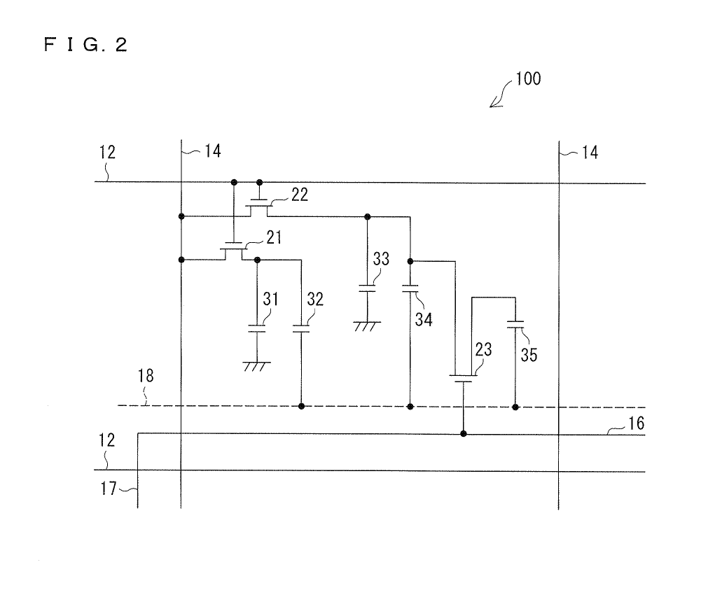

With reference to FIGS. 1 and 2, the following describes an arrangement of one of pixels provided on the substrate of the present embodiment for a liquid crystal display apparatus, and describes an equivalent circuit of the one pixel. FIG. 1 is a view illustrating a part of equivalent circuits 100 which are provided on the substrate of the present embodiment for a liquid crystal display apparatus. FIG. 2 is a view illustrating an equivalent circuit of one of pixels provided on the substrate of the present embodiment for a liquid crystal display apparatus.

As illustrated in FIGS. 1 and 2, the TFT substrate includes a plurality of gate bus lines 12 (a plurality of gate bus lines) and a plurality of source bus lines 14 (a plurality of source bus lines) which are formed so as to intersect with the plurality of gate bus lines 12 via an insulating film such as a SiN film. The plurality of gate bus lines 12 are, e.g., sequentially scanned. FIG. 1 illustrates the plurality of gate bus lines 12 as an n-th gate bus line 12n, an (n+1)th gate bus line 12(n+1), an (n+2)th gate bus line 12(n+2), and an (n+3)th gate bus line 12(n+3). In the vicinity of each of positions where the gate bus lines 12 and the source bus lines 14 intersect with each other, a TFT 21 (first transistor) and a TFT 22 (second transistor) are provided for one pixel so as to be adjacent to each other. A part of each of the gate bus lines 12 serves as gate electrodes of corresponding TFTs 21 and 22. Active semiconductor layers for the TFTs 21 and 22 are formed, e.g. integrally, on the gate bus lines 12 via the insulating film. Channel protecting films are formed, e.g. integrally, on the active semiconductor layers. Provided on each of the channel protecting films for the TFTs 21 are a combination of a source electrode and an n-type impurity semiconductor layer provided under the source electrode, and a combination of a drain electrode and an n-type impurity semiconductor layer provided under the drain electrode so that the combinations face each other via a predetermined gap. Similarly, provided on each of the channel protecting films for the TFTs 22 are a combination of a source electrode and an n-type impurity semiconductor layer provided under the source electrode, and a combination of a drain electrode and an n-type impurity semiconductor layer provided under the drain electrode so that the combinations face each other via a predetermined gap. The source electrodes of the TFTs 21 and 22 are electrically connected with the source bus lines 14. Each of the TFTs 21 and a corresponding TFT 22 are provided in parallel to each other.

(Arrangement of Equivalent Circuit 100)

Further, storage capacitor bus lines 18 (a plurality of storage capacitor bus lines) which are extended in parallel with the gate bus lines 12 are provided so as to intersect with pixel regions defined by the gate bus lines 12 and the source bus lines 14. Storage capacitor electrodes are provided pixel-by-pixel on the storage capacitor bus lines 18 via the insulating film. Each of the storage capacitor electrodes is electrically connected with a drain electrode of a corresponding TFT 21 via a connecting electrode. A storage capacitor 32 is formed between each of the storage capacitor bus lines 18 and a corresponding storage capacitor electrode which face each other via the insulating film.

Each of the pixel regions defined by the gate bus lines 12 and the source bus lines 14 is divided into a first subpixel and a second subpixel. In each of the pixel regions, a first subpixel and a second subpixel are provided substantially line symmetrically with respect to a corresponding storage capacitor bus line 18. A first pixel electrode is provided in the first subpixel, and a second pixel electrode which is separated from the first pixel electrode is provided in the second subpixel. The first and second pixel electrodes are realized by transparent conductive films made from a material such as ITO. Each of the first pixel electrodes is electrically connected with a corresponding storage capacitor electrode and with a drain electrode of a corresponding TFT 21. Each of the second pixel electrodes is electrically connected with a drain electrode of a corresponding TFT 22. Further, each of the second pixel electrodes includes an area which overlaps a corresponding storage capacitor bus line 18 via the protecting film and the insulating film. In this area, a storage capacitor 34 is formed between the second pixel electrode and the storage capacitor bus line 18 which face each other via the protecting film and the insulating films.

The counter substrate includes a CF resin layer which is formed on a glass substrate, and common electrodes which are formed on the CF resin layer. A liquid crystal capacitor 31 is formed between a first pixel electrode in each of the first subpixels formed on the TFT substrate which faces the counter substrate via the liquid crystal layer and a corresponding common electrode formed on the counter substrate. A liquid crystal capacitor 33 is formed between a second pixel electrode in each of the second subpixels formed on the TFT substrate and a corresponding common electrode formed on the counter substrate.

(Bus Line 16)

Further, bus lines 16 (bus lines) are provided in parallel with the gate bus lines 12 so as to intersect with the pixel regions defined by the gate bus lines 12 and the source bus lines 14. A TFT 23 (third transistor) is provided below each of the pixel regions. A gate electrode of the TFT 23 is electrically connected with a corresponding bus line 16. Provided on the gate electrodes via the insulating film are the active semiconductor layers. Provided on the active semiconductor layers are the channel protecting films. Provided on each of the channel protecting films are a combination of a source electrode and an n-type impurity semiconductor layer provided under the source electrode, and a combination of a drain electrode and an n-type impurity semiconductor layer provided under the drain electrode so that the combinations face each other via a predetermined gap. Each of the drain electrodes is electrically connected with a corresponding second pixel electrode. Provided in the vicinity of each of the TFTs 23 is a first buffer capacitor electrode which is electrically connected with a corresponding storage capacitor bus line 18 via a connecting electrode. Provided on the first buffer capacitor electrode via the insulating film is a second buffer capacitor electrode. The second buffer capacitor electrode is electrically connected with a corresponding source electrode. A buffer capacitor 35 (buffer capacitor section) is formed between the first buffer capacitor electrode and the second buffer capacitor electrode which face each other via the insulating film.

As illustrated in FIG. 1, the bus line 16n is connected with one end of an external bus line 17n (external bus line) in a picture-frame region which is a region outside a display region of the liquid crystal panel. The other end of the external bus line 17n is connected with the gate bus line 12(n+2). A gate bus line 12 with which the bus line 16n is connected is not limited to the gate bus line 12(n+2). For example, the bus line 16n may be connected with a gate bus line 12 which is an ‘m’-th one (m is an integer of not less than 2) forward from the gate bus line 12n. In this case, in the picture-frame region, the external bus line 17n is connected with one end of the bus line 16n, and the other end is connected with a gate bus line 12(n+m).

Further, an ‘m’ number of additional gate bus lines 12 (‘m’ number of additional gate bus lines) are provided in parallel with the existing gate bus lines 12 so as to follow a gate bus line 12 provided for a final line of pixels which constitute a display region of the liquid crystal panel (i.e., so as to follow a final gate bus line) among all the gate bus lines 12 provided for the pixels which constitute the display region. Accordingly, TFTs 23 corresponding to the final gate bus line 12 are connected with an ‘m’-th additional gate bus line 12. On the other hand, connected with an (m−x)th additional gate bus line 12 are TFTs 23 corresponding to a gate bus line 12 which is an ‘x’-th (‘x’ is an integer of not less than 1 but not more than (m−1)) one backward from the final gate bus line 12.

This makes it possible to prevent shortage of a gate bus line 12 to be connected with TFTs 23 corresponding to a gate bus line 12 which is the ‘x’-th one backward from the gate bus line 12 provided for the final line of pixels which constitute the display region among the plurality of gate bus lines 12. That is, in a case where the number of the gate bus lines 12 which are formed on the substrate for a liquid crystal display apparatus so as to be involved in image display is, e.g., 1080, “1080+m” is the number of the gate bus lines 12 to be actually formed on the substrate.

That is, the ‘m’ number of additional gate bus lines 12 are not directly involved in image display. That is, the ‘m’ number of additional gate bus lines 12 are provided so as to maintain a high viewing angle characteristic in such a manner that the ‘m’ number of additional gate bus lines 12 are used to turn on or turn off the TFTs 23 corresponding to any one of gate bus lines 12 from the final one to an ‘x’-th one backward from the final one, and an electric charge of each of pixels is thereby redistributed.

[Driving Method of Equivalent Circuit 100]

In the case of 3D display in a time-division manner, as described above, it is required to drive the substrate for a liquid crystal display apparatus at high speed. In order to drive the liquid crystal driving circuit at high speed, scanning signals are simultaneously supplied to the ‘m’ number of gate bus lines 12, respectively. The following deals with, as an example, such a case that the scanning signals are simultaneously supplied to every group of adjacent two of the gate bus lines 12 so that driving at 240 Hz is achieved by use of that liquid crystal driving circuit of a liquid crystal panel which is driven at 120 Hz.

In a case where the scanning signals are simultaneously supplied to every group of adjacent two of the gate bus lines 12, first of all, the scanning signals are simultaneously supplied to first and second ones of the gate bus line 12. Then, the scanning signals are simultaneously supplied to third and fourth ones of the gate bus lines 12. Similarly, the scanning signals are simultaneously supplied to subsequent two adjacent ones of the gate bus lines. Specifically, the scanning signals are simultaneously supplied to the n-th gate bus line 12n and the (n+1)th gate bus line 12(n+1). Then, the scanning signals are simultaneously supplied to the (n+2)th gate bus line 12(n+2) and the (n+3)th gate bus line 12(n+3). Similarly, the scanning signals are simultaneously supplied to every group of adjacent two of the gate bus lines 12 until all the gate bus lines 12 on the substrate for a liquid crystal display apparatus are scanned.

In the present embodiment, so-called reverse polarity driving is carried out in which a polarity of a data signal to be supplied to a source bus line 14 is reversed frame by frame. Specifically, in a case where a positive data signal is supplied to a source bus line 14 in one frame, a negative data signal is supplied to the source bus line 14 in a next frame. On the other hand, in a case where a negative data signal is supplied to a source bus line 14 in one frame, a positive data signal is supplied to the source bus line 14 in a next frame.

(Movement of Electric Charge in Pixel Corresponding Gate Bus Line 12n)

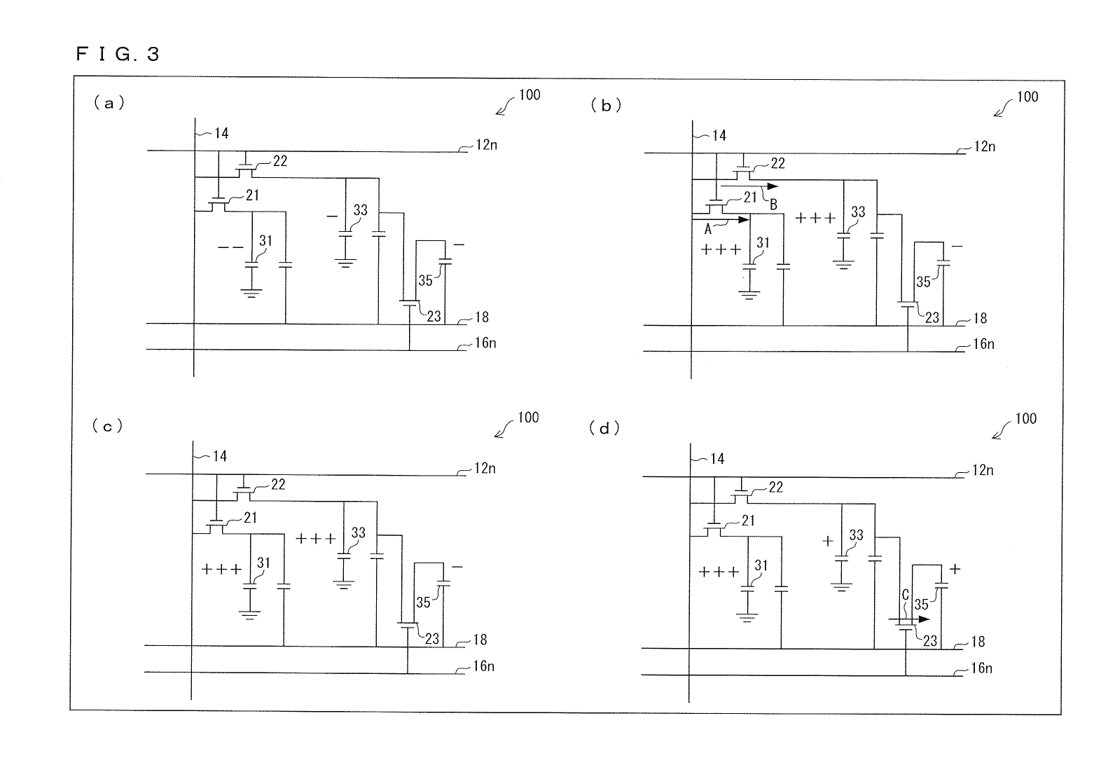

The following describes a method of the present embodiment for driving the liquid crystal display apparatus, with reference to FIG. 3. The following deals with a case where the “adjacent two of the gate bus lines” are the n-th gate bus line 12n and the (n+1)th gate bus line 12(n+1). Particularly, the following describes how an electric charge moves in a pixel in a case where a scanning signal is supplied to the n-th gate bus line 12n.

FIG. 3 illustrates how an electric charge moves in a pixel defined by the n-th gate bus line 12n and the source bus line 14 when the pixel is driven. (a) of FIG. 3 is a view illustrating a state where the n-th gate bus line 12n is not selected. (b) of FIG. 3 is a view illustrating how the electric charge flows in a case where the n-th gate bus line 12n is selected. (c) of FIG. 3 is a view illustrating a state where the n-th gate bus line 12n is deselected. (d) of FIG. 3 is a view illustrating how the electric charge flows in a case where the n-th bus line 16n is selected by selecting the (n+2)th gate bus line 12(n+2).

(Maintenance of State after Previous Scanning)

As illustrated in (a) of FIG. 3, first, an electric charge is maintained since the n-th gate bus line 12n has been previously selected so that a scanning signal is supplied thereto. In an example illustrated in (a) of FIG. 3, a negative charge is written in each of the liquid crystal capacitor 31, the liquid crystal capacitor 33, and the buffer capacitor 35.

(Scanning of N-th Gate Bus Line 12N)

Then, by simultaneously selecting the n-th gate bus line 12n and the (n+1)th gate bus line 12(n+1), scanning signals are supplied thereto. This causes a transition from the state illustrated in (a) of FIG. 3 to a state illustrated in (b) of FIG. 3. By supplying the scanning signal to the n-th gate bus line 12n, the TFTs 21 and 22 are turned on, as illustrated in (b) of FIG. 3. As indicated by arrows A and B in (b) of FIG. 3, accordingly, an electric charge of a data signal flows from the source bus line 14 to each of the liquid crystal capacitors 31 and 33 so that a positive charge is written in each of the liquid crystal capacitors 31 and 33. In this state, TFTs 23 which are connected with the (n+2)th gate bus line 12(n+1) remain turned off because the (n+2)th gate bus line 12(n+1) has not been scanned. Therefore, the buffer capacitor 35 retains the negative charge.

(End of Scanning of N-th Gate Bus Line 12n)

After the scanning of the n-th gate bus line 12n and the (n+1)th gate bus line 12(n+1) ends, the state illustrated in (b) of FIG. 3 transitions to a nonselected state which is illustrated in (c) of FIG. 3. In this state, the electric charge written in the state illustrated in (b) of FIG. 3 is retained as it is, as illustrated in (c) of FIG. 3. As illustrated in (c) of FIG. 3, each of the liquid crystal capacitors 31 and 33 retains the positive charge, and the buffer capacitor 35 retains the negative charge.

(Scanning of N-th Bus Line 16n)

Then, the (n+2)th gate bus line 12(n+2) and the (n+3)th gate bus line 12(n+3) are selected so that the scanning signals are supplied thereto. This causes a transition from the state illustrated in (c) of FIG. 3 to a state illustrated in (d) of FIG. 3. By selecting the (n+2)th gate bus line 12(n+2), the scanning signal is supplied to the n-th bus line 16n which is connected with the (n+2)th gate bus line 12(n+2) via the n-th external bus line 17n in the picture-frame region. Accordingly, the TFT 23 connected with the n-th bus line 16n is turned on. Accordingly, as indicated by an arrow C in (d) of FIG. 3, the positive charge which is retained by the liquid crystal capacitor 33 flows into the buffer capacitor 35 via the TFT 23. As a result, the liquid crystal capacitor 33 and the buffer capacitor 35 retain a same electric charge. The electric charge is thus redistributed.

On the other hand, the TFT 21 remains turned off, and accordingly, the electric charge retained by the liquid crystal capacitor 31 does not move. This makes it possible to cause a difference in electric potential between the liquid crystal capacitors 31 and 33 in high-speed driving in which two adjacent gate bus lines 12 are simultaneously selected. In other words, this makes it possible to cause a difference in electric potential between the first subpixel and the second subpixel. This makes it possible to maintain a high viewing angle characteristic.

After all the gate bus lines 12 on the substrate for a liquid crystal display apparatus are scanned, the gate bus lines 12 are scanned again from a pair of the first and second ones to subsequent pairs, and the n-th gate bus line 12n is scanned again. As described above, an electric charge to be written in a pixel is reversed in polarity frame by frame, i.e., every time the scanning is carried out. Therefore, the movement of the electric charge is repeated in the following manner: the state of (a) of FIG. 3→the state of (b) of FIG. 3→the state of (c) of FIG. 3→the state of (d) of FIG. 3→a state of (a) of FIG. 3 with a reversed polarity→a state of (b) of FIG. 3 with the reversed polarity→a state of (c) of FIG. 3 with the reversed polarity→a state of (d) of FIG. 3 with the reversed polarity→the state of (a) of FIG. 3.

(Movement of Electric Charge in Pixel Corresponding Gate Bus Line 12(n+1))

The above deals with the movement of the electric charge in the pixel defined by the n-th gate bus line 12n and the source bus line 14. In the high-speed driving, as described above, the (n+1)th gate bus line 12(n+1) is also selected simultaneously with the n-th gate bus line 12n. The following deals with how an electric charge moves when the (n+1)th gate bus line 12(n+1) is selected.

As is the case with the state illustrated in (a) of FIG. 3, as a result of a previous scanning, an electric charge is initially retained by each of the liquid crystal capacitor 31, the liquid crystal capacitor 33, and the buffer capacitor 35 which are formed in each of pixels which correspond to the (n+1)th gate bus line 12(n+1).

First, as is the case with the state illustrated in (b) of FIG. 3, the (n+1)th gate bus line 12(n+1) is scanned so that the TFTs 21 and 22 are turned on. As a result, an electric charge is written in each of the liquid crystal capacitors 31 and 33. In this state, an (n+1)th bus line 16(n+1) has not been selected, and accordingly, the corresponding TFT 23 remains turned off.

After the (n+1)th gate bus line 12(n+1) is scanned, as is the case with the state illustrated in (c) of FIG. 3, each of the liquid crystal capacitors 31 and 33 retains the written electric charge.

Then, by scanning the (n+3)th gate bus line 12(n+3), the (n+1)th bus line 16(n+1) is scanned which is connected with the (n+3)th gate bus line 12(n+3) via the (n+1)th external bus line 17(n+1) in the picture-frame region. Accordingly, the TFT 23 is turned on as is the case with the state illustrated in (d) of FIG. 3. This causes the electric charge retained by the liquid crystal capacitor 33 to flow into the buffer capacitor 35 via the TFT 23. On the other hand, the electric charge retained by the liquid crystal capacitor 31 does not move.

After all the gate bus lines 12 on the substrate for a liquid crystal display apparatus are scanned, the gate bus lines 12 are scanned again from a pair of the first and second ones to subsequent pairs, and the (n+1)th gate bus line 12(n+1) is scanned again. As described above, an electric charge to be written is reversed in polarity frame by frame, i.e., every time the scanning is carried out.

Thus, the movement of the electric charge in the pixel defined by the (n+1)th gate bus line 12(n+1) and the source bus line 14 occurs at the same timing as the movement of the electric charge in the pixel defined by the n-th gate bus line 12n and the source bus line 14. Specifically, the movement of the electric charge is repeated at the same timing in the following manner: the state of (a) of FIG. 3→the state of (b) of FIG. 3→the state of (c) of FIG. 3→the state of (d) of FIG. 3→the state of (a) of FIG. 3 with a reversed polarity→the state of (b) of FIG. 3 with the reversed polarity→the state of (c) of FIG. 3 with the reversed polarity→the state of (d) of FIG. 3 with the reversed polarity→the state of (a) of FIG. 3.

The above deals with, as an example, the driving method in which two adjacent gate bus lines 12 are simultaneously selected. However, the number of the gate lines 12 to be simultaneously selected in the high-speed driving is not limited to two. For example, the driving method may be such that an ‘m’ (m is an integer of not less than 2) number of gate bus lines 12 are simultaneously selected. In this case, electric charges move at the same timing which are retained by the liquid crystal capacitors 31 provided in pixels corresponding the ‘m’ number of gate bus lines 12 to be simultaneously selected. The same holds for the liquid crystal capacitors 33 and the buffer capacitors 35 provided in the pixels. That is, the movement of the electric charge is repeated in the following manner: the state of (a) of FIG. 3→the state of (b) of FIG. 3→the state of (c) of FIG. 3→the state of (d) of FIG. 3→the state of (a) of FIG. 3 with a reversed polarity→the state of (b) of FIG. 3 with the reversed polarity→the state of (c) of FIG. 3 with the reversed polarity→the state of (d) of FIG. 3 with the reversed polarity→the state of (a) of FIG. 3.

(Driving Method for Normal Driving)

Also in normal driving which is not required to be high-speed and in which the gate bus lines 12 are selected one by one so that a scanning signal is supplied thereto, needless to say, it is possible to cause a difference in electric potential between the liquid crystal capacitors 31 and 33, as is the case with the high-speed driving in which the ‘m’ number of gate bus lines 12 are simultaneously selected so that scanning signals are simultaneously supplied thereto. That is, a high viewing angle characteristic can also be maintained in the normal driving. The following describes how an electric charge moves in the normal driving.

As a result of a previous scanning, an electric charge is initially retained by each of the liquid crystal capacitor 31, the liquid crystal capacitor 33, and the buffer capacitor 35 which are formed in each of pixels which correspond to the n-th gate bus line 12n. First, the n-th gate bus line 12n is scanned so that the TFTs 21 and 22 are turned on. As a result, an electric charge is written in each of the liquid crystal capacitors 31 and 33. In this state, the bus line 16n has not been selected, and accordingly, the corresponding TFTs 23 remain turned off. After the n-th gate bus line 12n is scanned, each of the liquid crystal capacitors 31 and 33 retains the written electric charge. Then, the (n+1)th gate bus line 12(n+1) is selected so that the scanning signal is supplied thereto. However, this is not involved in the movement of electric charges retained by the liquid crystal capacitors 31, the liquid crystal capacitors 33, and the buffer capacitors 35 which are formed in the pixels corresponding to the n-th gate bus line 12n.

Then, by scanning the (n+2)th gate bus line 12(n+2), the n-th bus line 16n is scanned which is connected with the (n+2)th gate bus line 12(n+2) via the n-th external bus line 17n in the picture-frame region. Accordingly, the TFT 23 is turned on. This causes the electric charge retained by the liquid crystal capacitor 33 to flow into the buffer capacitor 35 via the TFT 23. On the other hand, the electric charge retained by the liquid crystal capacitor 31 does not move.

Thus, it is also possible to cause a difference in electric potential between the first subpixel and the second subpixel in the normal driving in which the gate bus lines 12 are selected one by one. This makes it possible to maintain a high viewing angle characteristic.

### Embodiment 2

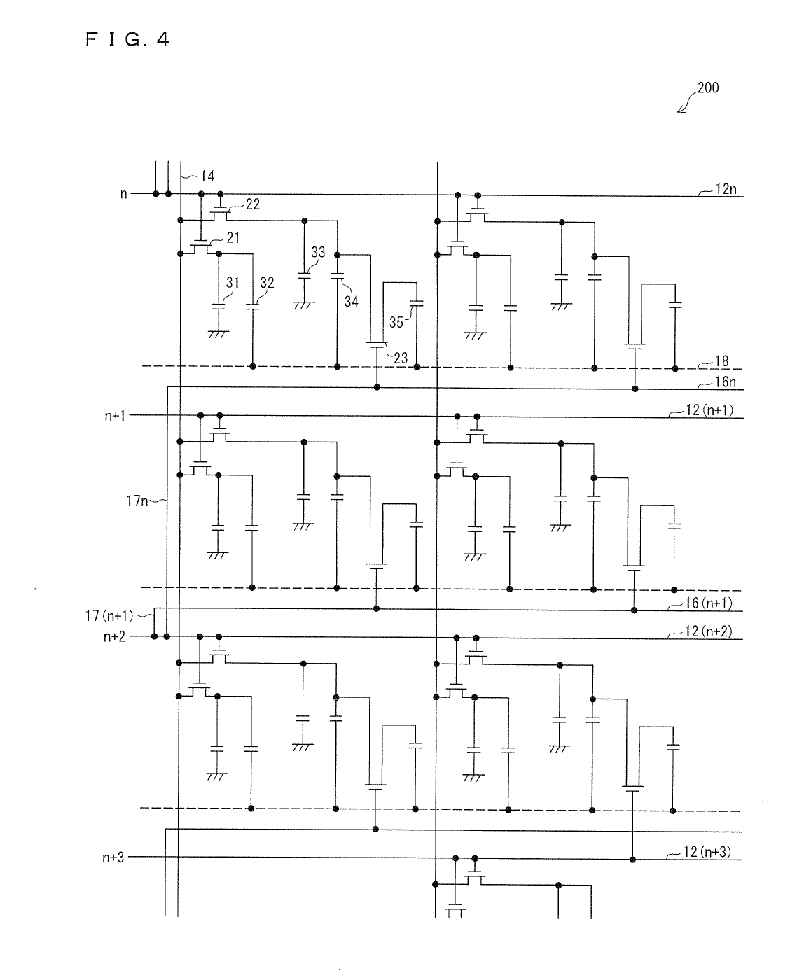

The following describes another embodiment of the present invention, with reference to FIG. 4. For convenience of explanation, members having the same functions as those of Embodiment 1 are given common reference numerals, and the following omits to describe such members. The present embodiment mainly deals with differences from Embodiment 1.

[Arrangement of Equivalent Circuit 200]

FIG. 4 is a view illustrating a part of equivalent circuits 200 of a liquid crystal display apparatus of the present embodiment. As illustrated in FIG. 4, the liquid crystal display apparatus is arranged in the same way as that of Embodiment 1, except that in the picture-frame region, one end of an (n+1)th external bus line 17(n+1) of a part of the equivalent circuits 200 of the liquid crystal display apparatus of the present embodiment is connected with one end of an (n+1)th bus line 16(n+1) and the other end is connected with an (n+2)th gate bus line 12(n+2). Further, in the picture-frame region, one end of an n-th external bus line 17n is connected with one end of an n-th bus line 16n and the other end is connected with the (n+2)th gate bus line 12(n+2), as is the case with the arrangement of Embodiment 1. Accordingly, the n-th bus line 16n and the (n+1)th bus line 16(n+1) are connected with the (n+2)th gate bus line 12(n+2) via the n-th external bus line 17n and the (n+1)th external bus line 17(n+1), respectively.

A gate bus line 12 with which the bus line 16n and the bus line 16(n+1) are connected is not limited to the (n+2)th gate bus line 12(n+2). That is, the bus line 16n and the bus line 16(n+1) may be connected with a (y×m+1)th gate bus line 12. ‘m’ is an integer of not less than 2, and indicates the number of gate bus lines 12 to be simultaneously selected in the high-speed driving. ‘y’ is a value obtained in such a manner that a quotient is found by dividing ‘n’ by ‘m’ and decimals of the quotient are rounded up to unit. That is, all the gate electrodes of TFTs 23 formed in pixels corresponding to the n-th through (n+m−1)th gate bus lines 12 are connected with an (n+m)th gate bus line 12.

Further, one additional gate bus line (additional gate bus line) 12 is provided in parallel with the gate bus lines 12 so as to follow a gate bus line 12 which is provided for a final line of pixels which constitute a display region (i.e., so as to follow a final gate bus line) among all the gate bus lines 12 provided for the pixels which constitute the display region. That is, in a case where the number of the gate bus lines 12 which are formed on the substrate for a liquid crystal display apparatus so as to be involved in image display is, e.g., 1080, “1080+1” is the number of the gate bus lines 12 to be actually formed on the substrate.

TFTs 23 corresponding to the final gate bus line 12 are connected with the additional gate bus line 12. Further, also connected with the additional gate bus line 12 are TFTs 23 corresponding to a gate bus line 12 which is ‘x’-th (‘x’ is an integer of not less than 1 but not more than m−1) one backward from the final gate bus line 12.

This makes it possible to prevent shortage of a gate bus line 12 to be connected with TFTs 23 corresponding to a gate bus line 12 which is the ‘x’-th one backward from the gate bus line 12 provided for the final line of pixels which constitute the display region among the plurality of gate bus lines 12.

The one additional gate bus line 12 is not directly involved in image display. That is, the one additional gate bus line 12 is provided so as to maintain a high viewing angle characteristic in such a manner that the one additional gate bus line 12 is used to turn on or turn off the TFTs 23 corresponding to the bus lines 16 from the final one to the ‘x’-th one backward from the final one, and an electric charge of each of pixels is thereby redistributed.

[Driving Method of Equivalent Circuit 200]

A method of the present embodiment for driving a liquid crystal display apparatus is the same as that of Embodiment 1, except that the gate bus line 12(n+2) is scanned so that the TFTs 23 are turned on or off which are provided in pixels corresponding to the n-th gate bus line 12n and the (n+1)th gate bus line 12(n+1).

The following deals with such an example that scanning signals are simultaneously supplied to every group of two adjacent gate bus lines 12.

In the present embodiment, so-called reverse polarity driving is carried out in which a polarity of a data signal to be supplied to a source bus line 14 is reversed frame by frame. Specifically, in a case where a positive data signal is supplied to a source bus line 14 in one frame, a negative data signal is supplied to the source bus line 14 in a next frame. On the other hand, in a case where a negative data signal is supplied to a source bus line 14 in one frame, a positive data signal is supplied to the source bus line 14 in a next frame.

(Movement of Electric Charge in Pixel Corresponding Gate Bus Line 12n)

The following first deals with, particularly, movement of an electric charge in each of pixels which correspond to the n-th gate bus line 12n out of the n-th and (n+1)th ones to which the scanning signals are simultaneously supplied.

As is the case with the state illustrated in (a) of FIG. 3, as a result of a previous scanning, an electric charge is initially retained by each of the liquid crystal capacitor 31, the liquid crystal capacitor 33, and the buffer capacitor 35 which are formed in each of pixels which correspond to the n-th gate bus line 12n. First, as is the case with the state illustrated in (b) of FIG. 3, the n-th gate bus line 12n is scanned so that the TFTs 21 and 22 are turned on. As a result, an electric charge is written in each of the liquid crystal capacitors 31 and 33. In this state, the n-th bus line 16n has not been selected, and accordingly, the corresponding TFTs 23 remain turned off. After the n-th gate bus line 12n is scanned, as is the case with the state illustrated in (c) of FIG. 3, each of the liquid crystal capacitors 31 and 33 retains the written electric charge.

Then, by scanning the (n+2)th gate bus line 12(n+2) and the (n+3)th gate bus line 12(n+3), the n-th bus line 16n is scanned which is connected with the (n+2)th gate bus line 12(n+2) via the n-th external bus line 17n in the picture-frame region. Accordingly, the TFT 23 is turned on, as is the case with the state illustrated in (d) of FIG. 3. This causes the electric charge retained by the liquid crystal capacitor 33 to flow into the buffer capacitor 35 via the TFT 23. On the other hand, the electric charge retained by the liquid crystal capacitor 31 does not move.

After all the gate bus lines 12 on the substrate for a liquid crystal display apparatus are scanned, the gate bus lines 12 are scanned again from a pair of the first and second ones to subsequent pairs, and the n-th gate bus line 12n is scanned again. As described above, an electric charge to be written is reversed in polarity frame by frame, i.e., every time the scanning is carried out. Therefore, the movement of the electric charge is repeated in the following manner: the state of (a) of FIG. 3→the state of (b) of FIG. 3→the state of (c) of FIG. 3→the state of (d) of FIG. 3→a state of (a) of FIG. 3 with a reversed polarity→a state of (b) of FIG. 3 with the reversed polarity→a state of (c) of FIG. 3 with the reversed polarity→a state of (d) of FIG. 3 with the reversed polarity→the state of (a) of FIG. 3.

(Movement of Electric Charge in Pixel Corresponding Gate Bus Line 12(n+1))

The following first deals with, particularly, movement of an electric charge in each of pixels which correspond to the (n+1)th gate bus line 12(n+1) out of the n-th and (n+1)th ones to which the scanning signals are simultaneously supplied.

As is the case with the state illustrated in (a) of FIG. 3, as a result of a previous scanning, an electric charge is initially retained by each of the liquid crystal capacitor 31, the liquid crystal capacitor 33, and the buffer capacitor 35 which are formed in each of pixels corresponding to the (n+1)th gate bus line 12(n+1). First, as is the case with the state illustrated in (b) of FIG. 3, the (n+1)th gate bus line 12(n+1) is scanned so that the TFTs 21 and 22 are turned on. As a result, an electric charge is written in each of the liquid crystal capacitors 31 and 33. In this state, the (n+1)th bus line 16(n+1) has not been selected, and accordingly, the corresponding TFTs 23 remain turned off. After the (n+1)th gate bus line 12(n+1) is scanned, as is the case with the state illustrated in (c) of FIG. 3, each of the liquid crystal capacitors 31 and 33 retains the written electric charge.

Then, by scanning the (n+2)th gate bus line 12(n+2) and the (n+3)th gate bus line 12(n+3), the (n+1)th bus line 16(n+1) is scanned which is connected with the (n+2)th gate bus line 12(n+2) via the (n+1)th external bus line 17(n+1) in the picture-frame region. Accordingly, the TFT 23 is turned on, as is the case with the state illustrated in (d) of FIG. 3. This causes the electric charge retained by the liquid crystal capacitor 33 to flow into the buffer capacitor 35 via the TFT 23. On the other hand, the electric charge retained by the liquid crystal capacitor 31 does not move.

After all the gate bus lines 12 on the substrate for a liquid crystal display apparatus are scanned, the gate bus lines 12 are scanned again from a pair of the first and second ones to subsequent pairs, and the (n+1)th gate bus line 12(n+1) is scanned again. As described above, an electric charge to be written is reversed in polarity frame by frame, i.e., every time the scanning is carried out.

Thus, the movement of the electric charge in the pixel defined by the (n+1)th gate bus line 12(n+1) and the source bus line 14 occurs at the same timing as the movement of the electric charge in the pixel defined by the n-th gate bus line 12n and the source bus line 14. Specifically, the movement of the electric charge is repeated in the following manner: the state of (a) of FIG. 3→the state of (b) of FIG. 3→the state of (c) of FIG. 3→the state of (d) of FIG. 3→the state of (a) of FIG. 3 with a reversed polarity→the state of (b) of FIG. 3 with the reversed polarity→the state of (c) of FIG. 3 with the reversed polarity→the state of (d) of FIG. 3 with the reversed polarity→the state of (a) of FIG. 3.

That method for driving the liquid crystal display apparatus which is employed in the high-speed driving is not limited to the driving method in which two adjacent gate bus lines 12 are simultaneously selected. For example, the method may be such that an ‘m’ (‘m’ is an integer of not less than 2) number of gate lines 12 are simultaneously selected. Also in this case, the n-th bus line 16n which is connected with the gate electrodes of the TFTs 23 provided in the pixels corresponding to the n-th gate bus line 12n is connected with the (y×m+1)th gate bus line 12 via the external bus line 17 in the picture-frame region (‘m’ is an integer of not less than 2, and ‘y’ is a value found in such a manner that a quotient is found by dividing ‘n’ by ‘m’ and decimals of the quotient are rounded up to unit). It follows that the gate electrodes of the TFTs 23 provided in the pixels corresponding to the n-th gate bus line 12n are connected with the (y×m+1)th gate bus line 12.

(Driving Method for Normal Driving)

Also in normal driving which is not required to be high-speed and in which the gate bus lines 12 are selected one by one so that a scanning signal is supplied thereto, needless to say, it is possible to cause a difference in electric potential between the liquid crystal capacitors 31 and 33, as is the case with the high-speed driving in which the ‘m’ number of gate bus lines 12 are simultaneously selected so that scanning signals are simultaneously supplied thereto. That is, a high viewing angle characteristic can also be maintained in the normal driving. The following describes how an electric charge moves in the normal driving.

As a result of a previous scanning, an electric charge is initially retained by each of the liquid crystal capacitor 31, the liquid crystal capacitor 33, and the buffer capacitor 35 which are formed in each of pixels corresponding to the n-th gate bus line 12n and the (n+1)th gate bus line 12(n+1). First, the n-th gate bus line 12n is scanned so that the TFTs 21 and 22 are turned on. As a result, an electric charge is written in each of the liquid crystal capacitors 31 and 33. In this state, the bus line 16n has not been selected, and accordingly, the corresponding TFTs 23 remain turned off. After the n-th gate bus line 12n is scanned, each of the liquid crystal capacitors 31 and 33 retains the written electric charge.

Then, the (n+1)th gate bus line 12(n+1) is scanned so that those TFTs 21 and 22 are turned on which are formed in the pixels corresponding to the (n+1)th gate bus line 12(n+1). As a result, an electric charge is written in each of the liquid crystal capacitors 31 and 33. In each of the pixels corresponding to the n-th gate bus line 12n, on the other hand, an electric charge does not move to each of the liquid crystal capacitor 31, the liquid crystal capacitor 33, and the buffer capacitor 35.

Then, by scanning the (n+2)th gate bus line 12(n+2), the n-th bus line 16n is scanned which is connected with the (n+2)th gate bus line 12(n+2) via the n-th external bus line 17n in the picture-frame region. Simultaneously, the (n+1)th bus line 16(n+1) is also scanned which is connected with the (n+2)th gate bus line 12(n+2) via the (n+1)th external bus line 17(n+1). In the pixels corresponding to the n-th bus line 16n and the (n+1)th bus line 16(n+1), the TFTs 23 are turned on. In each of the pixels, this causes the electric charge retained by the liquid crystal capacitor 33 to flow into the buffer capacitor 35 via the TFT 23. On the other hand, the electric charge retained by the liquid crystal capacitor 31 does not move.

Thus, it is also possible to cause a difference in electric potential between the first subpixel and the second subpixel in the normal driving in which the gate bus lines 12 are selected one by one. This makes it possible to maintain a high viewing angle characteristic.

The substrate of the present invention for a liquid crystal display apparatus preferably further includes: a bus line being provided in parallel with the n-th one of the plurality of gate bus lines, said bus line being electrically connected with the gate electrodes of said third transistors corresponding thereto; and an external bus lines being provided outside a display region containing whole of said pixel regions, said external bus line each being electrically connected with the (n+m)th one of the plurality of gate bus lines and with said bus line corresponding thereto.

According to the arrangement, the gate electrodes of the third transistors provided in the pixels corresponding to the n-th gate bus line do not have to be provided so as to be directly connected with the (n+m)th gate bus line across a gate bus line corresponding to the next line of pixels. This makes it possible to provide the gate electrodes, without extending the gate electrodes. This makes it possible to maintain a high viewing angle characteristic, without reducing an area of the pixels.

The substrate of the present invention for a liquid crystal display apparatus preferably further includes: an ‘m’ number of additional gate bus lines being provided in parallel with the plurality of gate bus lines so as to follow a final one of the plurality of gate bus lines, an m-th one of the ‘m’ number of additional gate bus lines being connected with third transistors corresponding to the final one of the plurality of gate bus lines among said third transistors, and an (m−x)th one of the ‘m’ number of additional gate bus lines being connected with third transistors corresponding to a gate bus line which is an ‘x’-th one backward from the final one of the plurality of gate bus lines among said third transistors, where ‘x’ is an integer of not less than 1 but not more than (m−1).

This makes it possible to prevent shortage of a gate bus line to be connected with, among the bus lines, a bus line which is an ‘x’-th (‘x’ is an integer of not less than 1 but not more than (m−1)) one backward from the bus line corresponding to the line of pixels corresponding to the final gate bus line, i.e., backward from the bus line corresponding to the final line of pixels which constitute the display region. This makes it possible to cause the redistribution of the electric charge in the pixels corresponding to the gate bus line to be finally scanned. As a result, a high viewing angle characteristic can be maintained.

The substrate for a liquid crystal display apparatus preferably further includes: a bus line being provided in parallel with the n-th one of the plurality of gate bus lines, said bus line being electrically connected with the gate electrodes of said third transistors corresponding thereto; and an external bus lines being provided outside a display region containing whole of said pixel regions, said external bus line each being electrically connected with the (y×m+1)th one of the plurality of gate bus lines and with said bus line corresponding thereto.

According to the arrangement, the gate electrodes of the third transistors provided in the pixels corresponding to the n-th gate bus line do not have to be provided so as to be directly connected with the (y×m+1)th gate bus line across a gate bus line corresponding to the next line of pixels. This makes it possible to provide the gate electrodes, without extending the gate electrodes. This makes it possible to maintain a high viewing angle characteristic, without reducing an area of the pixels.

The substrate for a liquid crystal display apparatus preferably further includes: one additional gate bus line being provided in parallel with the plurality of gate bus lines so as to follow a final one of the plurality of gate bus lines, said one additional gate bus line being connected with third transistors corresponding to the final one of the plurality of gate bus lines among said third transistors, and said one additional gate bus line being connected with third transistors corresponding to a gate bus line which is an ‘x’-th one backward from the final one of the plurality of gate bus lines among said third transistors, where ‘x’ is an integer of not less than 1 but not more than (m−1).

This makes it possible to prevent shortage of a gate bus line to be connected with, among the bus lines, a bus line which is an ‘x’-th (‘x’ is an integer of not less than 1 but not more than (m−1)) one backward from the bus line corresponding to the line of pixels corresponding to the final gate bus line, i.e., backward from the bus line corresponding to the final line of pixels which constitute the display region. This makes it possible to cause the redistribution of the electric charge in the pixels corresponding to the gate bus line to be finally scanned. As a result, a high viewing angle characteristic can be maintained.

A liquid crystal display apparatus of the present invention includes: a liquid crystal panel including the substrate for a liquid crystal display apparatus, a counter substrate on which a common electrode is provided, and a liquid crystal layer being provided between said substrate and said counter substrate; and scanning signal supply means for supplying scanning signals to every group of ‘m’ number of adjacent ones of the plurality of gate bus lines.

This makes it possible to provide a liquid crystal display apparatus which can maintain a high viewing angle characteristic even in high-speed driving.

### INDUSTRIAL APPLICABILITY

The liquid crystal display apparatus of the present invention is suitably applicable to TVs, monitors of personal computers, portable phones, etc.

### REFERENCE SIGNS LIST

12 Gate bus line (plurality of gate bus lines)
12n N-th gate bus line
12(n+1) (n+1)th gate bus line
12(n+2) (n+2)th gate bus line
12(n+3) (n+3)th gate bus line
14 Source bus line (plurality of source bus lines)
16 Bus line (bus line)
16n N-th bus line
16(n+1) (n+1)th bus line
17 External bus line (external bus line)
17n N-th external bus line
17(n+1) (n+1)th external bus line
18 Storage capacitor bus line (a plurality of storage capacitor bus lines)
21 TFT (first transistor)
22 TFT (second transistor)
23 TFT (third transistor)
31 Liquid crystal capacitor
32 Storage capacitor
33 Liquid crystal capacitor
34 Storage capacitor
35 Buffer capacitor (buffer capacitor section)
100, 200 Equivalent circuit

1. A substrate for a liquid crystal display apparatus, comprising:
a plurality of gate bus lines being provided in parallel with each other on a substrate;
a plurality of source bus lines being formed so as to intersect with the plurality of gate bus lines with an insulating film interposed between the plurality of source bus lines and the plurality of gate bus lines;
a plurality of storage capacitor bus lines being formed in parallel with the plurality of gate bus lines;
first transistors;
second transistors;
each of said first transistors and said second transistors including (i) a gate electrode which is electrically connected with an n-th one of the plurality of gate bus lines and (ii) a source electrode which is electrically connected with one of the plurality of source bus lines,
first pixel electrodes each being electrically connected with the drain electrode of a corresponding one of said first transistors;
second pixel electrodes each being electrically connected with the drain electrode of a corresponding one of said second transistors, said second pixel electrodes each being separated from said first pixel electrodes;
pixel regions each including (I) a first subpixel in which a corresponding one of said first pixel electrodes is provided, and (II) a second subpixel in which a corresponding one of said second pixel electrodes is provided;
third transistors each including (a) a gate electrode which is electrically connected with an (n+m)th one of the plurality of gate bus lines, where ‘m’ is an integer of not less than 2, and (b) a drain electrode which is electrically connected with a corresponding one of said second pixel electrodes; and
buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film.

2. The substrate for a liquid crystal display apparatus as set forth in claim 1, further comprising:
a bus line being provided in parallel with the n-th one of the plurality of gate bus lines, said bus line being electrically connected with the gate electrodes of said third transistors corresponding thereto; and
an external bus lines being provided outside a display region containing whole of said pixel regions, said external bus line each being electrically connected with the (n+m)th one of the plurality of gate bus lines and with said bus line corresponding thereto.

3. The substrate for a liquid crystal display apparatus as set forth in claim 1 further comprising:
an ‘m’ number of additional gate bus lines being provided in parallel with the plurality of gate bus lines so as to follow a final one of the plurality of gate bus lines, an m-th one of the ‘m’ number of additional gate bus lines being connected with third transistors corresponding to the final one of the plurality of gate bus lines among said third transistors, and
an (m−x)th one of the ‘m’ number of additional gate bus lines being connected with third transistors corresponding to a gate bus line which is an ‘x’-th one backward from the final one of the plurality of gate bus lines among said third transistors, where ‘x’ is an integer of not less than 1 but not more than (m−1).

4. A substrate for a liquid crystal display apparatus, comprising:
a plurality of gate bus lines being provided in parallel with each other on a substrate;
a plurality of source bus lines being formed so as to intersect with the plurality of gate bus lines with an insulating film interposed between the plurality of source bus lines and the plurality of gate bus lines;
a plurality of storage capacitor bus lines being formed in parallel with the plurality of gate bus lines;
first transistors;
second transistors;
each of said first transistors and said second transistors including (i) a gate electrode which is electrically connected with an n-th one of the plurality of gate bus lines and (ii) a source electrode which is electrically connected with one of the plurality of source bus lines,
first pixel electrodes each being electrically connected with the drain electrode of a corresponding one of said first transistors;
second pixel electrodes each being electrically connected with the drain electrode of a corresponding one of said second transistors, said second pixel electrodes each being separated from said first pixel electrodes;
pixel regions each including (I) a first subpixel in which a corresponding one of said first pixel electrodes is provided, and (II) a second subpixel in which a corresponding one of said second pixel electrodes is provided;
third transistors each including (a) a gate electrode which is electrically connected with a (y×m+1)th one of the plurality of gate bus lines, where ‘m’ is an integer of not less than 2, and ‘y’ is found in such a manner that a quotient is found by dividing ‘n’ by ‘m’ and decimals of the quotient are rounded up to unit, and (b) a drain electrode which is electrically connected with a corresponding one of said second pixel electrodes; and
buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film.

5. The substrate for a liquid crystal display apparatus as set forth in claim 4, further comprising:
a bus line being provided in parallel with the n-th one of the plurality of gate bus lines, said bus line being electrically connected with the gate electrodes of said third transistors corresponding thereto; and
an external bus lines being provided outside a display region containing whole of said pixel regions, said external bus line each being electrically connected with the (y×m+1)th one of the plurality of gate bus lines and with said bus line corresponding thereto.

6. The substrate for a liquid crystal display apparatus as set forth in claim 4, further comprising:
one additional gate bus line being provided in parallel with the plurality of gate bus lines so as to follow a final one of the plurality of gate bus lines,
said one additional gate bus line being connected with third transistors corresponding to the final one of the plurality of gate bus lines among said third transistors, and
said one additional gate bus line being connected with third transistors corresponding to a gate bus line which is an ‘x’-th one backward from the final one of the plurality of gate bus lines among said third transistors, where ‘x’ is an integer of not less than 1 but not more than (m−1).

7. A liquid crystal display apparatus comprising:
a liquid crystal panel including
a substrate, recited in claim 1, for a liquid crystal display apparatus,
a counter substrate on which a common electrode is provided, and
a liquid crystal layer being provided between said substrate and said counter substrate; and
scanning signal supply means for supplying scanning signals to every group of ‘m’ number of adjacent ones of the plurality of gate bus lines.

8. A method for driving a liquid crystal display apparatus which includes a substrate for the liquid crystal display apparatus,
the substrate including:
a plurality of gate bus lines being provided in parallel with each other on a substrate;
a plurality of source bus lines being formed so as to intersect with the plurality of gate bus lines with an insulating film interposed between the plurality of source bus lines and the plurality of gate bus lines;
a plurality of storage capacitor bus lines being formed in parallel with the plurality of gate bus lines;
first transistors;
second transistors;
each of said first transistors and said second transistors including (i) a gate electrode which is electrically connected with an n-th one of the plurality of gate bus lines and (ii) a source electrode which is electrically connected with one of the plurality of source bus lines,
first pixel electrodes each being electrically connected with the drain electrode of a corresponding one of said first transistors;
second pixel electrodes each being electrically connected with the drain electrode of a corresponding one of said second transistors, said second pixel electrodes each being separated from said first pixel electrodes;
pixel regions each including (I) a first subpixel in which a corresponding one of said first pixel electrodes is provided, and (II) a second subpixel in which a corresponding one of said second pixel electrodes is provided;
third transistors each including (a) a gate electrode which is electrically connected with an (n+m)th one of the plurality of gate bus lines, where ‘m’ is an integer of not less than 2, and (b) a drain electrode which is electrically connected with a corresponding one of said second pixel electrodes; and
buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film,
the method comprising a step of supplying scanning signals to every group of ‘m’ number of adjacent ones of the plurality of gate bus lines.

9. A method for driving a liquid crystal display apparatus which includes a substrate for a liquid crystal display apparatus,
the substrate including:
a plurality of gate bus lines being provided in parallel with each other on a substrate;
a plurality of source bus lines being formed so as to intersect with the plurality of gate bus lines with an insulating film interposed between the plurality of source bus lines and the plurality of gate bus lines;
a plurality of storage capacitor bus lines being formed in parallel with the plurality of gate bus lines;
first transistors;
second transistors;
each of said first transistors and said second transistors including (i) a gate electrode which is electrically connected with an n-th one of the plurality of gate bus lines and (ii) a source electrode which is electrically connected with one of the plurality of source bus lines,
first pixel electrodes each being electrically connected with the drain electrode of a corresponding one of said first transistors;
second pixel electrodes each being electrically connected with the drain electrode of a corresponding one of said second transistors, said second pixel electrodes each being separated from said first pixel electrodes;
pixel regions each including (I) a first subpixel in which a corresponding one of said first pixel electrodes is provided, and (II) a second subpixel in which a corresponding one of said second pixel electrodes is provided;
third transistors each including (a) a gate electrode which is electrically connected with a (y×m+1)th one of the plurality of gate bus lines, where ‘m’ is an integer of not less than 2, and ‘y’ is found in such a manner that a quotient is found by dividing ‘n’ by ‘m’ and decimals of the quotient are rounded up to unit, and (b) a drain electrode which is electrically connected with a corresponding one of said second pixel electrodes; and
buffer capacitor sections each including (A) a first buffer capacitor electrode which is electrically connected with the source electrode of a corresponding one of said third transistors and (B) a second buffer capacitor electrode which is electrically connected with a corresponding one of the plurality of storage capacitor bus lines, the second buffer capacitor electrode facing the first buffer capacitor electrode via the insulating film,
the method comprising a step of supplying scanning signals to every group of ‘m’ number of adjacent ones of the plurality of gate bus lines.
